(19) United States
(12) Patent Application Publication
(10) Pub. No.: US 2026/0139607 A1
(43) Pub. Date: May 21, 2026

(54) ACOUSTIC WAVE SENSOR SYSTEM FOR A PROPULSION SYSTEM

(71) Applicant: General Electric Company, Schenectady, NY (US)

(72) Inventors: Douglas Scott Jacobs, Boston, MA (US); Marco Francesco Aimi, Niskayuna, NY (US)

(21) Appl. No.: 18/519,394

(22) Filed: Nov. 27, 2023

(51) Int. Cl. F01D 21/00

(52) U.S. Cl. CPC F01D 21/003; F05D 2260/80

(57) ABSTRACT

A propulsion system includes a component and a multi-layer sensing device mounted to the component. The multi-layer sensing device includes a first substrate layer, a first adhesive layer securing the first substrate layer to the component, and a second substrate layer arranged in a stacked configuration with the first substrate layer. The second substrate layer is spaced apart from the first substrate layer by a gap. The multi-layer sensing device further includes a second adhesive layer arranged between the first and second substrate layers to maintain the gap. Thus, the multi-layer sensing device provides passive compensation of viscoelastic creep of the multi-layer sensing device.

### FIELD

The present disclosure relates to propulsion systems and, more particularly, to sensor systems for propulsion systems, such as acoustic wave sensor systems for propulsion systems having improved resistance to viscoelastic creep.

### BACKGROUND

In the field of gas turbine engines, it may be important to closely monitor and accurately measure the torque output of the engine to understand engine performance and health. By closely monitoring output torque values, potential problems can be identified before they occur. For instance, lower than expected torque output can be indicative of sub-optimal engine operation. In addition, output torque values can be used to estimate the life and/or maintenance cycle of various engine components. Real time measurement of output torque values can permit the estimations of the life of an engine component which can be repeatedly updated and revised. Moreover, real time measurement of output torque can be used to guarantee that the required output power is available at any given time.

Measurements of torque are only useful to the degree that they can be considered accurate. Current methods for measuring torque can be limited in their ability to consistently gather accurate information from a rotating shaft. For instance, some systems rely on reluctance sensors to monitor shaft rotation. Such systems can use rotational readings to estimate shaft strain generated at the shaft away from the sensor location. However, by relying on rotational readings alone, relevant information on strain (e.g., thermal strain) can be lost. For instance, existing systems may fail to account for or evaluate the thermal environment at a relevant strain location. This can lead to inaccurate torque measurements.

Other systems can detect shaft strain in order to determine torque. However, these systems may provide only a single signal path for such measurements. If any point along the single path is interrupted, measurements might be lost or compromised. Merely duplicating a single path system may lead to interference and/or conflicting measurements between the duplicated systems. Therefore, existing systems can often be at risk for failing to provide accurate or reliable measurements of torque.

Moreover, existing strain-based sensing systems can require regular service to provide accurate strain measurements due to, for instance, the effects of long term drift or reliability of these systems. The operation of the measured part or apparatus may lead to deviations from the calibration and require recalibration of the sensing system. In the case of a gas turbine engine, the maintenance required for calibration or recalibration can be prohibitively time consuming, repetitive, and/or expensive.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic view of a gas turbine engine according to the present disclosure;

FIG. 2 is a perspective view of an embodiment of a shaft of a gas turbine engine having a sensing system mounted thereto according to the present disclosure;

FIG. 3 is a schematic diagram of an embodiment of a surface acoustic wave (SAW) sensing device and associated circuitry according to the present disclosure;

FIG. 4 is a schematic diagram of an embodiment of a bulk acoustic wave (BAW) sensing device and associated circuitry according to the present disclosure;

FIG. 5 illustrates a cross-sectional view of an embodiment of a multi-layer sensing device mounted to a shaft of a gas turbine engine according to the present disclosure;

FIG. 6 is a block diagram of an embodiment of a controller of a sensing system of a gas turbine engine according to the present disclosure;

FIG. 7 is a graph of a measurement change, such as torque, (y-axis) versus time (x-axis) of a sensing system of a gas turbine engine according to the present disclosure;

FIG. 8 is a graph of strain (y-axis) versus time (x-axis) of a sensing system of a gas turbine engine according to the present disclosure; and

FIG. 9 is a flow diagram illustrating a method of passively compensating for viscoelastic creep of a sensing device of a gas turbine engine according to the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The term “turbomachine” refers to a machine including one or more compressors, a heat generating section (e.g., a combustion section), and/or one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “propulsion system” refers to a system having an electrical machine and/or a turbomachine to provide thrust to a vehicle, such as an aeronautical vehicle, a land-based vehicle, a watercraft, or similar. The propulsion system may include one or more gas turbine engines, one or more propulsors driven by a respective electric machine, or a combination thereof.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., –er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” of the engine.

The terms “forward” and “aft” refer to relative positions within a gas turbine engine or vehicle and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the terms “axial” and “axially” refer to directions and orientations that extend substantially parallel to a centerline of the gas turbine engine. Moreover, the terms “radial” and “radially” refer to directions and orientations that extend substantially perpendicular to the centerline of the gas turbine engine. In addition, as used herein, the terms “circumferential” and “circumferentially” refer to directions and orientations that extend arcuately about the centerline of the gas turbine engine.

The terms “coupled”, “fixed”, “attached to”, and the like refer to both direct coupling, fixing, or attaching, as well as indirect coupling, fixing, or attaching through one or more intermediate components or features, unless otherwise specified herein.

As used herein, the terms “first”, “second”, and so on may be used interchangeably to distinguish one component from another and are not intended to signify location or importance of the individual components.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

When subjected to stress, viscoelastic materials experience a time-dependent decrease in modulus, and thus transferred strain. This phenomenon is known as viscoelastic creep. Viscoelastic creep is an error source of current acoustic wave torque sensing devices, particularly at elevated temperatures, such as temperatures experienced during operation of gas turbine engines. As such, the present disclosure is directed to sensing devices manufactured with specifically balanced stresses over time to eliminate/reduce creep so as to eliminate/reduce this error. Thus, the sensing devices of the present disclosure have improved performance as compared to prior art systems. Moreover, the sensing devices of the present disclosure provide passive compensation of viscoelastic creep, by optimizing the geometry and material properties of a multi-layer structure.

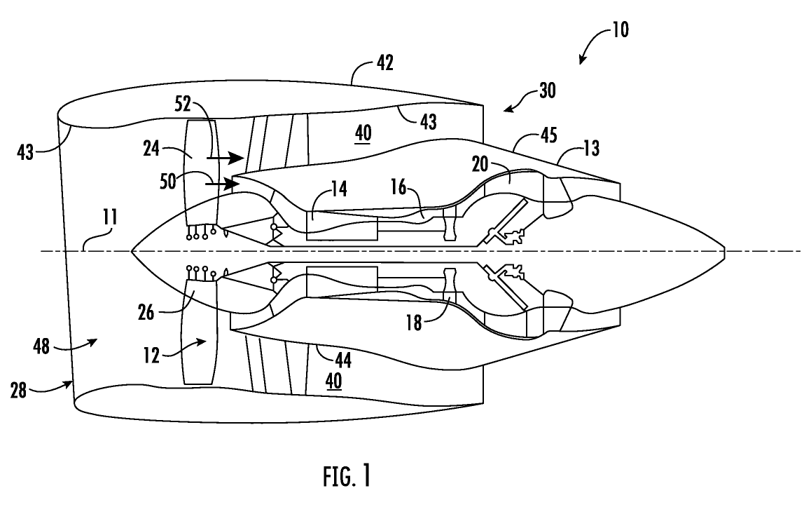

Referring now to the drawings, wherein identical numerals indicate the same elements throughout the figures, FIG. 1 is a schematic view of an embodiment of a gas turbine engine 10 having a longitudinal axis 11 according to the present disclosure. Further, as shown, the gas turbine engine 10 includes a fan assembly 12, and a core engine 13. The core engine 13 includes a high pressure compressor 14, a combustor 16, and a high pressure turbine 18. In an embodiment, the gas turbine engine 10 may also include a low pressure turbine 20. The fan assembly 12 includes an array of fan blades 24 extending radially outward from a rotor disk 26. The gas turbine engine 10 has an intake side 28 and an exhaust side 30. Further, the gas turbine engine 10 may also include a plurality of bearing assemblies (not shown in FIG. 1) that are utilized to provide rotational and axial support to the fan assembly 12, the compressor 14, the high pressure (HP) turbine 18, and/or the low pressure (LP) turbine 20, for example. Further, the HP turbine 18 and the LP turbine 20 have a HP shaft and LP shaft, respectively. In an embodiment, the gas turbine engine 10 may also have internal gearboxes, power take off assemblies, and hybrid electric coupled machines.

In operation, an inlet airflow 48 flows through the fan assembly 12 and is split by an airflow splitter 44 into a first portion 50 and a second portion 52. The first portion 50 of the airflow is channeled through the compressor 14 wherein the airflow is further compressed and delivered to the combustor 16. Hot products of combustion (not shown in FIG. 1) from the combustor 16 are utilized to drive the HP and LP turbines 18, 20 and thus produce engine thrust. Moreover, the gas turbine engine 10 also includes a bypass duct 40 that is utilized to bypass a second portion 52 of the airflow discharged from the fan assembly 12 around the core engine 13. More specifically, the bypass duct 40 extends between an inner wall 43 of a fan casing or shroud 42 and an outer wall 45 of the airflow splitter 44.

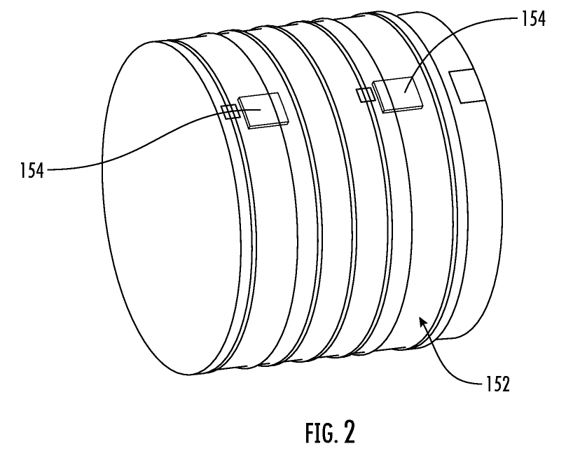

Referring now particularly to FIG. 2, a perspective view of an embodiment of a sensor system 150 according to the present disclosure is illustrated. More specifically, as shown, the shaft 152 may be any shaft in the gas turbine engine 10, such as a power take-off shaft, a shaft in the fan assembly 12, the compressor 14, the HP turbine 18, the LP turbine 20, or an engine coupling shaft of the gas turbine engine, and so on. Furthermore, it should be understood that the shaft 152 may be a rotating shaft of the gas turbine engine or a static structure of the gas turbine engine.

Moreover, as shown in FIG. 2, the sensing system 150 may include one or more multi-layer sensing devices 154, such as a plurality of multi-layer sensing devices 154, secured circumferentially around and onto the shaft 152 of the gas turbine engine. For example, the sensing system 150 may include any suitable number of sensing devices 154 positioned in any suitable arrangement on the shaft 152.

In certain embodiments, the multi-layer sensing device(s) 154 described herein may include, for example, at least one of one or more devices capable of measuring temperature, one or more devices capable of measuring strain, or combinations thereof. In certain embodiments, for example, one or more of the multi-layer sensing device(s) 154 may be capable of measuring only strain. In another embodiment, one or more of the sensing device(s) 154 may be capable of measuring strain and temperature. In still further embodiments, the sensing system 150 may include a combination of device(s) which are capable of measuring strain and device(s) which are capable of measuring strain and temperature. In addition, in an embodiment, the sensing system 150 can measure torque, or the strain may be used to estimate torque.

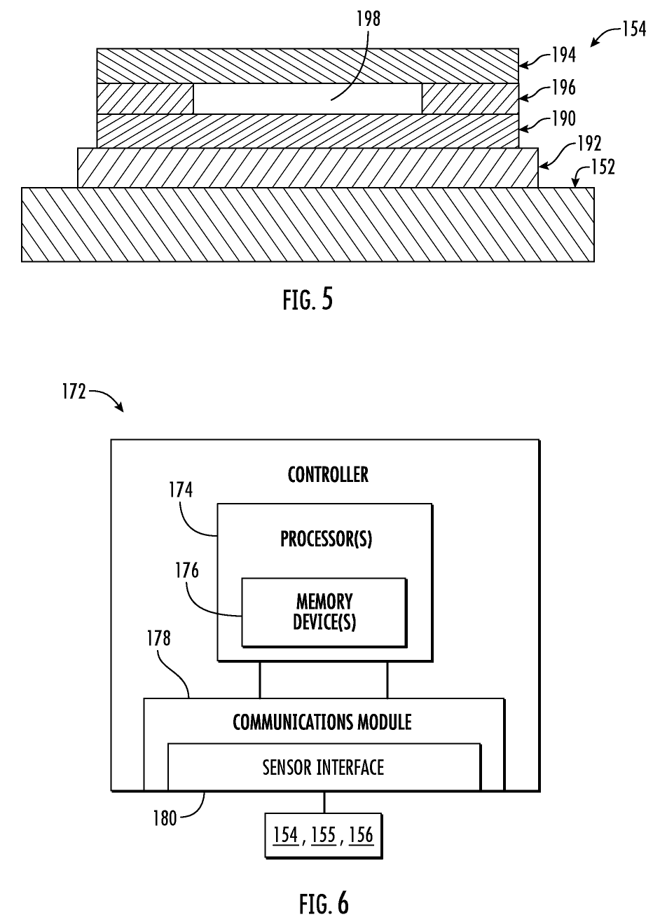

Moreover, in an embodiment, the multi-layer sensing device(s) 154 described herein may include, for example, surface acoustic wave (SAW) sensors 156, bulk acoustic wave (BAW) sensors 155, or similar. For example, in an embodiment, as shown particularly in FIG. 5, the sensing device(s) 154 described herein may include SAW sensors 156. As used herein, the SAW sensors 156 generally rely on the modulation of surface acoustic waves to sense a physical phenomenon. Thus, the SAW sensor(s) 156 described herein is configured to transduce an input electrical signal into a mechanical wave using, e.g., a phase shifter 166 and/or an amplifier 168. As such, unlike an electrical signal, the mechanical wave can be easily influenced by physical phenomena. Accordingly, as shown in FIG. 5, the SAW sensor(s) 156 can then transduce the mechanical wave back into an electrical signal to generate an output 164. Changes in amplitude, phase, frequency, or time-delay between the input and output electrical signals can be used to measure the presence of the desired phenomenon.

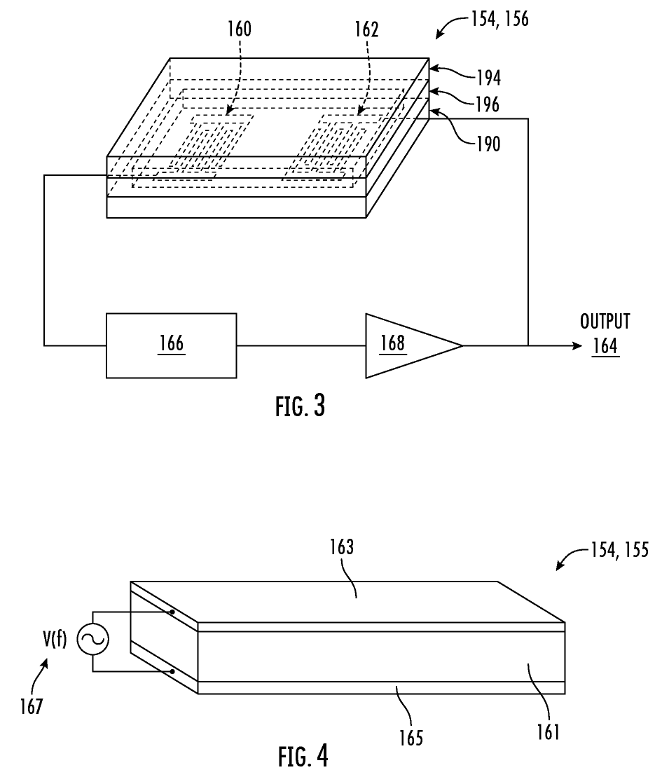

More specifically, in an embodiment such as shown in FIG. 3, the SAW sensor 156 generally includes a substrate 158 with an input interdigitated transducer (IDT) 160 on one side of the surface of the substrate 158 and an output IDT 162 on the other side of the substrate 158. The space between the IDTs 160, 162 across which the surface acoustic wave propagates is known as a delay line 170. The signal produced by the input IDT 160 (i.e., a physical wave) moves much slower than its associated electromagnetic form, causing a measurable delay. As such, the aforementioned phenomena can all cause a change in length along the surface of the SAW sensor 156. A change in length affects both the spacing between the interdigitated electrodes and the spacing between the IDTs 160, 162. This change can be sensed as a phase-shift, frequency-shift, or time-delay in the output 164.

In another embodiment, as shown in FIG. 4, the sensing device(s) 154 described herein may include BAW sensors 155. As used herein, the BAW sensors 155 described herein generally refers to an electromechanical device in which a standing acoustic wave is generated by an electrical signal in the bulk of a piezoelectric material. For example, as shown in the embodiment of FIG. 4, an example BAW sensor 155 is illustrated as having a piezoelectric material 161 (typically quartz, AlN, or ZnO) sandwiched between two metallic electrodes 163, 165. Further, as shown, a voltage 167 (e.g., V(f)) can be applied to the electrodes 163, 165 to induce strain of the piezoelectric material 161, and vice versa. Thus, after mechanical strain of the piezoelectric material 161 is experienced, a voltage can be read out of the electrodes 163, 165. As such, in an embodiment, the natural frequency of the piezoelectric material 161 and the thickness are used as design parameters to obtain a desired operating frequency. Other types of SAW devices may have any number of IDTs, and may share both input and output transduction, or may also use reflection IDTs.

Thus, the sensing device(s) 154 described herein are configured to sense a parameter of the shaft 152 or engine structure in one or more circumferentially spaced locations. For example, in an embodiment, the parameter of the shaft 152 in the circumferentially spaced location(s) may include temperature, strain, frequency, torque, speed, or combinations thereof.

Referring now to FIG. 5, a cross-sectional view of an embodiment of the multi-layer sensing device 154 is illustrated according to the present disclosure. More specifically, as shown, the multi-layer sensing device 154 includes a first substrate layer 190, a first adhesive layer 192 securing the first substrate layer 190 to the shaft 152, and a second substrate layer 194 arranged in a stacked configuration with the first substrate layer 190. For example, in an embodiment, the first substrate layer 190 and the second substrate layer 194 may be constructed of any suitable material, such as a piezoelectric material. In particular embodiments, for example, the first and second substrate layers 190, 194 may be constructed of a first quartz layer and a second quartz layer, respectively.

Further, as shown in FIG. 5, the second substrate layer 194 is spaced apart from the first substrate layer 190 by a gap 198. Moreover, as shown, the multi-layer sensing device 154 includes a second adhesive layer 196 arranged between the first and second substrate layers 190, 194 to maintain the gap 198. As such, the multi-layer sensing device 154 of the present disclosure provides passive compensation of viscoelastic creep of the multi-layer sensing device 154, e.g., by providing strain input from both the first and second adhesive layers 192, 196 onto the first substrate layer 190 where the measurement device typically exists. In further embodiments, the multi-layer structure may also have additional adhesive or substrate layers.

In particular embodiments, as an example, the passive compensation of the viscoelastic creep of the multi-layer sensing device 154 is provided by viscoelastic creep mechanical energy stored in the second adhesive layer 196 that counteracts viscoelastic creep mechanical energy of the first adhesive layer 192 across various operating temperatures of the gas turbine engine 10. In an embodiment, the viscoelastic creep mechanical energy stored in the second adhesive layer 196 is in a reverse direction as the viscoelastic creep mechanical energy of the first adhesive layer 192 due to strain reaction of the second substrate layer 194.

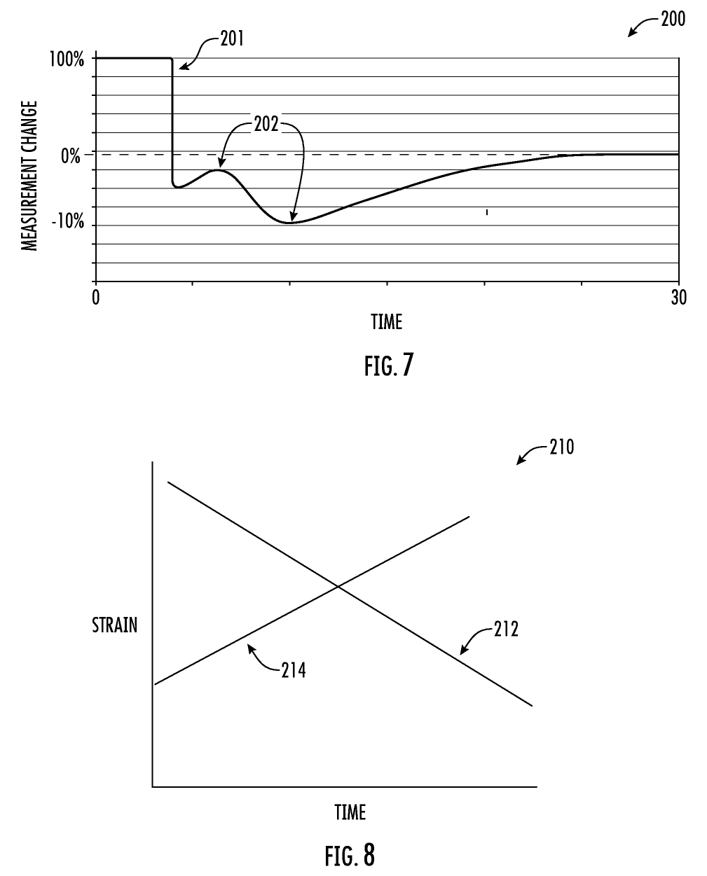

More specifically, the passive compensation of the viscoelastic creep of the multi-layer sensing device 154 can be better understood with reference to FIGS. 10 and 11. In particular, as shown in FIG. 7, a graph 200 of measurement change (y-axis), such as indicated torque, versus time (x-axis) is illustrated according to the present disclosure. Thus, as shown, drop 201 indicates the time of the measurement change. Further, as shown at 202, the bi-directional behavior of the multi-layer sensing device 154 is visible, with each adhesive layer viscoelastic creep relaxation occurring at different time constants. Moreover, as shown in FIG. 8, a graph 210 of strain being applied to the measurement substrate (e.g., the first substrate layer 190) (y-axis) versus time (x-axis) is illustrated according to the present disclosure. In particular, as shown, line 212 represents the strain of the first substrate layer 190 applied from the base material (e.g., the shaft 152) with viscoelastic effects of the first adhesive layer 192, whereas line 214 represents the strain of the first substrate layer 190 applied from the second substrate layer 194 and with viscoelastic effects of the second adhesive layer 196. Thus, as shown, the effects of the applied strain over time applied to the first substrate layer 190 from both the first adhesive layer 192 and the second adhesive layer 196 are counter to each other.

In particular embodiments, various characteristics of the multi-layer sensing device 154 can be selected to provide the passive compensation of viscoelastic creep of the multi-layer sensing device 154. In certain embodiments, the characteristics of the multi-layer sensing device 154 include an adhesive layer thickness, an adhesive layer size, an adhesive layer modulus, a substrate material type, a substrate material thickness, or similar.

Furthermore, in an embodiment, the sensing system 150 may include a controller 172 communicatively coupled to the sensing device(s) 154. For example, as shown in FIG. 6, a block diagram of an embodiment of suitable components that may be included within the controller 172 in accordance with example aspects of the present disclosure is illustrated. As shown, the controller 172 may include one or more processor(s) 174, computer, or other suitable processing unit and associated memory device(s) 176 that may include suitable computer-readable instructions that, when implemented, configure the controller to perform various different functions, such as receiving, transmitting and/or executing engine control signals (e.g., performing the methods, steps, calculations, and the like disclosed herein).

The processor(s) 174 may include a digital signal processor (DSP), an application specific integrated circuit (ASIC), a field programmable gate array (FPGA) or other programmable logic device, discrete gate or transistor logic, discrete hardware components, or any combination thereof designed and programmed to perform or cause the performance of the functions described herein. The processor(s) 174 may also include a microprocessor, or a combination of the aforementioned devices (e.g., a combination of a DSP and a microprocessor, a plurality of microprocessors, one or more microprocessors in conjunction with a DSP core, or any other such configuration).

Furthermore, as used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 176 may generally include memory element(s) including, but not limited to, computer readable medium (e.g., random access memory (RAM)), computer readable non-volatile medium (e.g., a flash memory, EEPROM, NVRAM, or FRAM), a floppy disk, a compact disc-read only memory (CD-ROM), a magneto-optical disk (MOD), a digital versatile disc (DVD) and/or other suitable memory elements. Accordingly, the memory device(s) 176 can store information accessible by processor(s), including instructions that can be executed by processor(s) and configuration parameters. For example, the instructions can be software or any set of instructions that when executed by the processor(s) 174, cause the processor(s) 174 to perform operations. For certain embodiments, the instructions include a software package configured to operate the system 150 to, e.g., execute the method 300 described herein.

Additionally, the controller 172 may also include a communications interface 178 to facilitate communications between the controller 172 and the various components of the gas turbine engine 10 and/or the sensing device(s) 154. An interface can include one or more circuits, terminals, pins, contacts, conductors, or other components for sending and receiving control signals. Moreover, the controller 172 may include a sensor interface 180 (e.g., one or more analog-to-digital converters) to permit signals transmitted from the various sensors described herein to be converted into signals that can be understood and processed by the processor(s) 174.

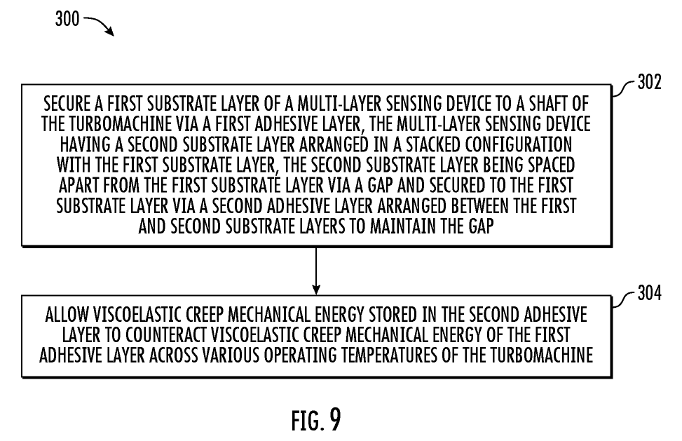

Referring now to FIG. 9, a flow diagram of an embodiment of a method 300 of passively compensating for viscoelastic creep of a sensing device of a gas turbine engine according to the present disclosure is illustrated. The method 300 described herein is generally explained with reference to the sensing system 150 illustrated in FIGS. 2-8; however, it should be understood that the method 300 can be applied to any suitable system having a shaft or structure. Furthermore, it should be appreciated that the method 300 is discussed herein only to describe aspects of the present disclosure and is not intended to be limiting. Further, though FIG. 9 depicts the method 300 having steps performed in a particular order for purposes of illustration and discussion, those of ordinary skill in the art, using the disclosures provided herein, will understand that the steps of any of the methods discussed herein can be adapted, rearranged, expanded, omitted, or modified in various ways without deviating from the scope of the present disclosure.

In particular, as shown at (302), the method 300 includes securing a first substrate layer of a multi-layer sensing device to a shaft of the gas turbine engine via a first adhesive layer, the multi-layer sensing device having a second substrate layer arranged in a stacked configuration with the first substrate layer, the second substrate layer spaced apart from the first substrate layer by a gap and secured to the first substrate layer via a second adhesive layer arranged between the first and second substrate layers to maintain the gap. As shown at (304), the method 300 includes allowing viscoelastic creep mechanical energy stored in the second adhesive layer to counteract viscoelastic creep mechanical energy of the first adhesive layer across various operating temperatures of the gas turbine engine.

Viscoelastic creep is an error source of current acoustic wave torque sensing devices, particularly at elevated temperatures, such as temperatures experienced during operation of gas turbine engines. As such, the present disclosure is directed to sensing devices manufactured with specifically balanced stresses over time to eliminate/reduce creep so as to eliminate/reduce this error, thereby improving performance of the sensing devices. Moreover, the sensing devices of the present disclosure provide passive compensation of viscoelastic creep, by optimizing the geometry and material properties of a multi-layer structure to improve the overall performance. In particular, the present disclosure uses the viscoelastic creep mechanical energy stored in a secondary layer across various times and temperatures, to counteract the viscoelastic creep behavior of the primary adhesive layer. Improved accuracy in torque sensing can contribute directly to more accurate thrust or shaft power monitoring, as well as gearbox reliability improvements and limit protection.

Further aspects are provided by the subject matter of the following clauses:

A propulsion system, comprising: a component; and a multi-layer sensing device mounted to the component, the multi-layer sensing device comprising: a first substrate layer; a first adhesive layer securing the first substrate layer to the component; a second substrate layer arranged in a stacked configuration with the first substrate layer, the second substrate layer spaced apart from the first substrate layer by a gap; and a second adhesive layer arranged between the first and second substrate layers to maintain the gap, wherein the multi-layer sensing device provides passive compensation of viscoelastic creep of the multi-layer sensing device.

The propulsion system of any preceding clause, wherein the passive compensation of the viscoelastic creep of the multi-layer sensing device is provided by viscoelastic creep mechanical energy stored in the second substrate layer that counteracts viscoelastic creep mechanical energy of the first substrate layer across various operating temperatures of the propulsion system.

The propulsion system of any preceding clause, wherein the viscoelastic creep mechanical energy stored in the second substrate layer is in a reverse direction as the viscoelastic creep mechanical energy of the first substrate layer.

The propulsion system of any preceding clause, wherein one or more characteristics of the multi-layer sensing device are selected to provide the passive compensation of viscoelastic creep of the multi-layer sensing device.

The propulsion system of any preceding clause, wherein the one or more characteristics of the multi-layer sensing device comprise at least one of an adhesive layer thickness, an adhesive layer size, an adhesive layer modulus, a substrate material type, a substrate material thickness, or a substrate size.

The propulsion system of any preceding clause, wherein the multi-layer sensing device comprises at least one of a surface acoustic wave (SAW) sensor or a bulk acoustic wave (BAW) sensor.

The propulsion system of any preceding clause, wherein the multi-layer sensing device comprises at least one of a temperature sensing device, a strain sensing device, a torque sensing device, a viscosity sensing device, a pressure sensing device, or combinations thereof.

The propulsion system of any preceding clause wherein the first substrate layer and the second substrate layer are constructed of a first quartz layer and a second quartz layer, respectively.

The propulsion system of any preceding clause, wherein the component is one of a gearbox shaft, a power take-off shaft, a low pressure turbine shaft, a high pressure turbine shaft, a fan shaft, or an engine coupling shaft of the propulsion system.

A method of passively compensating for viscoelastic creep of a sensing device of a propulsion system, the method comprising: securing a first substrate layer of a multi-layer sensing device to a component of the propulsion system via a first adhesive layer, the multi-layer sensing device having a second substrate layer arranged in a stacked configuration with the first substrate layer, the second substrate layer spaced apart from the first substrate layer by a gap and secured to the first substrate layer via a second adhesive layer arranged between the first and second substrate layers to maintain the gap; and allowing viscoelastic creep mechanical energy stored in the second adhesive layer to counteract viscoelastic creep mechanical energy of the first adhesive layer.

The method of any preceding clause, wherein the viscoelastic creep mechanical energy stored in the second substrate layer is in a reverse direction as the viscoelastic creep mechanical energy of the first substrate layer.

The method of any preceding clause, further comprising selecting one or more characteristics of the multi-layer sensing device to provide passive compensation of viscoelastic creep of the multi-layer sensing device.

The method of any preceding clause, wherein the one or more characteristics of the multi-layer sensing device comprise at least one of an adhesive layer thickness, an adhesive layer size, an adhesive layer modulus, a substrate material type, a substrate material thickness, or a substrate size.

The method of any preceding clause, wherein the multi-layer sensing device comprises at least one of a surface acoustic wave (SAW) sensor or a bulk acoustic wave (BAW) sensor.

A sensor system for a propulsion system, the sensor system comprising: a multi-layer sensing device for mounting to a component of the propulsion system, the multi-layer sensing device comprising: a first substrate layer; a first adhesive layer for securing the first substrate layer to the component; a second substrate layer arranged in a stacked configuration with the first substrate layer, the second substrate layer spaced apart from the first substrate layer by a gap; and a second adhesive layer arranged between the first and second substrate layers to maintain the gap, wherein the multi-layer sensing device provides passive compensation of viscoelastic creep of the multi-layer sensing device.

The sensor system of any preceding clause, wherein the passive compensation of the viscoelastic creep of the multi-layer sensing device is provided by viscoelastic creep mechanical energy stored in the second substrate layer that counteracts viscoelastic creep mechanical energy of the first substrate layer across various temperatures.

The sensor system of any preceding clause, wherein the viscoelastic creep mechanical energy stored in the second substrate layer is in a reverse direction as the viscoelastic creep mechanical energy of the first substrate layer.

The sensor system of any preceding clause, wherein one or more characteristics of the multi-layer sensing device are selected to provide the passive compensation of viscoelastic creep of the multi-layer sensing device, the one or more characteristics of the multi-layer sensing device comprising at least one of an adhesive layer thickness, an adhesive layer size, an adhesive layer modulus, a substrate material type, a substrate material thickness, or a substrate size.

The sensor system of any preceding clause, wherein the multi-layer sensing device comprises at least one of a surface acoustic wave (SAW) sensor or a bulk acoustic wave (BAW) sensor.

The sensor system of any preceding clause, wherein the multi-layer sensing device comprises at least one of a temperature sensing device, a strain sensing device, a torque sensing device, or combinations thereof.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A propulsion system, comprising:
a component; and
a multi-layer sensing device mounted to the component, the multi-layer sensing device comprising:
a first substrate layer;
a first adhesive layer securing the first substrate layer to the component;
a second substrate layer arranged in a stacked configuration with the first substrate layer, the second substrate layer spaced apart from the first substrate layer by a gap; and
a second adhesive layer arranged between the first and second substrate layers to maintain the gap,
wherein the multi-layer sensing device provides passive compensation of viscoelastic creep of the multi-layer sensing device.

2. The propulsion system of claim 1, wherein the passive compensation of the viscoelastic creep of the multi-layer sensing device is provided by viscoelastic creep mechanical energy stored in the second substrate layer that counteracts viscoelastic creep mechanical energy of the first substrate layer across various operating temperatures of the propulsion system.

3. The propulsion system of claim 2, wherein the viscoelastic creep mechanical energy stored in the second substrate layer is in a reverse direction as the viscoelastic creep mechanical energy of the first substrate layer.

4. The propulsion system of claim 1, wherein one or more characteristics of the multi-layer sensing device are selected to provide the passive compensation of viscoelastic creep of the multi-layer sensing device.

5. The propulsion system of claim 4, wherein the one or more characteristics of the multi-layer sensing device comprise at least one of an adhesive layer thickness, an adhesive layer size, an adhesive layer modulus, a substrate material type, a substrate material thickness, or a substrate size.

6. The propulsion system of claim 1, wherein the multi-layer sensing device comprises at least one of a surface acoustic wave (SAW) sensor or a bulk acoustic wave (BAW) sensor.

7. The propulsion system of claim 1, wherein the multi-layer sensing device comprises at least one of a temperature sensing device, a strain sensing device, a torque sensing device, a viscosity sensing device, a pressure sensing device, or combinations thereof.

8. The propulsion system of claim 1, wherein the first substrate layer and the second substrate layer are constructed of a first quartz layer and a second quartz layer, respectively.

9. The propulsion system of claim 1, wherein the component is one of a gearbox shaft, a power take-off shaft, a low pressure turbine shaft, a high pressure turbine shaft, a fan shaft, or an engine coupling shaft of the propulsion system.

10. A method of passively compensating for viscoelastic creep of a sensing device of a propulsion system, the method comprising:
securing a first substrate layer of a multi-layer sensing device to a component of the propulsion system via a first adhesive layer, the multi-layer sensing device having a second substrate layer arranged in a stacked configuration with the first substrate layer, the second substrate layer spaced apart from the first substrate layer by a gap and secured to the first substrate layer via a second adhesive layer arranged between the first and second substrate layers to maintain the gap; and
allowing viscoelastic creep mechanical energy stored in the second adhesive layer to counteract viscoelastic creep mechanical energy of the first adhesive layer.

11. The method of claim 10, wherein the viscoelastic creep mechanical energy stored in the second substrate layer is in a reverse direction as the viscoelastic creep mechanical energy of the first substrate layer.

12. The method of claim 10, further comprising selecting one or more characteristics of the multi-layer sensing device to provide passive compensation of viscoelastic creep of the multi-layer sensing device.

13. The method of claim 12, wherein the one or more characteristics of the multi-layer sensing device comprise at least one of an adhesive layer thickness, an adhesive layer size, an adhesive layer modulus, a substrate material type, a substrate material thickness, or a substrate size.

14. The method of claim 10, wherein the multi-layer sensing device comprises at least one of a surface acoustic wave (SAW) sensor or a bulk acoustic wave (BAW) sensor.

15. A sensor system for a propulsion system, the sensor system comprising:
a multi-layer sensing device for mounting to a component of the propulsion system, the multi-layer sensing device comprising:
a first substrate layer;
a first adhesive layer for securing the first substrate layer to the component;
a second substrate layer arranged in a stacked configuration with the first substrate layer, the second substrate layer spaced apart from the first substrate layer by a gap; and
a second adhesive layer arranged between the first and second substrate layers to maintain the gap,
wherein the multi-layer sensing device provides passive compensation of viscoelastic creep of the multi-layer sensing device.

16. The sensor system of claim 15, wherein the passive compensation of the viscoelastic creep of the multi-layer sensing device is provided by viscoelastic creep mechanical energy stored in the second substrate layer that counteracts viscoelastic creep mechanical energy of the first substrate layer across various temperatures.

17. The sensor system of claim 16, wherein the viscoelastic creep mechanical energy stored in the second substrate layer is in a reverse direction as the viscoelastic creep mechanical energy of the first substrate layer.

18. The sensor system of claim 15, wherein one or more characteristics of the multi-layer sensing device are selected to provide the passive compensation of viscoelastic creep of the multi-layer sensing device, the one or more characteristics of the multi-layer sensing device comprising at least one of an adhesive layer thickness, an adhesive layer size, an adhesive layer modulus, a substrate material type, a substrate material thickness, or a substrate size.

19. The sensor system of claim 15, wherein the multi-layer sensing device comprises at least one of a surface acoustic wave (SAW) sensor or a bulk acoustic wave (BAW) sensor.

20. The sensor system of claim 15, wherein the multi-layer sensing device comprises at least one of a temperature sensing device, a strain sensing device, a torque sensing device, or combinations thereof.
